(19) United States
(12) Patent Application Publication
(10) Pub. No.: US 2004/0218952 A1
(43) Pub. Date: Nov. 4, 2004

(54) Insertion-speed controlled paper input tray

(76) Inventors: Cherng Linn Teo, Singapore (SG); Wui Jein Koh, Singapore (SG); Kok Chai Chong, Singapore (SG)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/425,779

(22) Filed: Apr. 29, 2003

(51) Int. Cl. G03G 15/00

(52) U.S. Cl. 399/393

(57) ABSTRACT

A printer comprises a paper tray that cannot be slammed in too fast by a user. The speed at which the paper tray can be reinserted is limited in order to stop bunching of the paper stacks up against the front datum walls. Such bunching has been a source of multiple feeds, misfeeds and paper jams. Embodiments of the present invention limit the speed of tray insertion by the user by interposing dampers, or homing motors.

### BACKGROUND

1. Field of the Invention

The present invention relates generally to printers, and more particularly to printers and input trays with controlled insertion speeds.

2. Background of the Invention

Some desktop printers have paper trays that need to be pulled out periodically and resupplied with paper sheets or other print media. During printing, individual paper sheets are sequentially picked out of the input tray and advanced to an image printing mechanism.

Users tend to slam the paper trays back into the printer hard enough to cause the paper to bunch up against the front datum wall, especially if the printer uses a slanted front datum wall design. Such bunching can interfere with the printer's ability to pick up individual sheets for the image printing mechanism. At worst, the bunching leads directly to paper jams.

### SUMMARY OF THE INVENTION

Briefly, a printer embodiment of the present invention includes a paper tray that cannot be slammed in too fast by a user. The speed at which the paper tray can be reinserted is limited to stop bunching of the paper stacks up against the front datum walls. Such bunching has been a source of multiple feeds, misfeeds and paper jams. Embodiments of the present invention limit the speed of tray insertion by the user by interposing dampers, or homing motors.

These and other objects and advantages of the present invention will no doubt become obvious to those of ordinary skill in the art after having read the following detailed description of the preferred embodiment as illustrated in the drawings.

### BRIEF DESCRIPTION OF THE DRAWINGS

FIGS. 1A and 1B are exploded perspective diagrams of a first printer embodiment of the present invention, illustrating different positions of an input tray respectively;

FIG. 2A is a cut-away partial diagram of a second printer embodiment of the present invention;

FIG. 2B is a top view of a damper used in the printer of FIG. 2A;

FIG. 2C is a cross section view of the damper of FIG. 2B;

FIG. 3A is an exploded perspective diagram of a third printer embodiment of the present invention; and

FIGS. 3B and 3C are simplified top views illustrating different status of an input tray of the printer of FIG. 3A.

### DETAILED DESCRIPTION

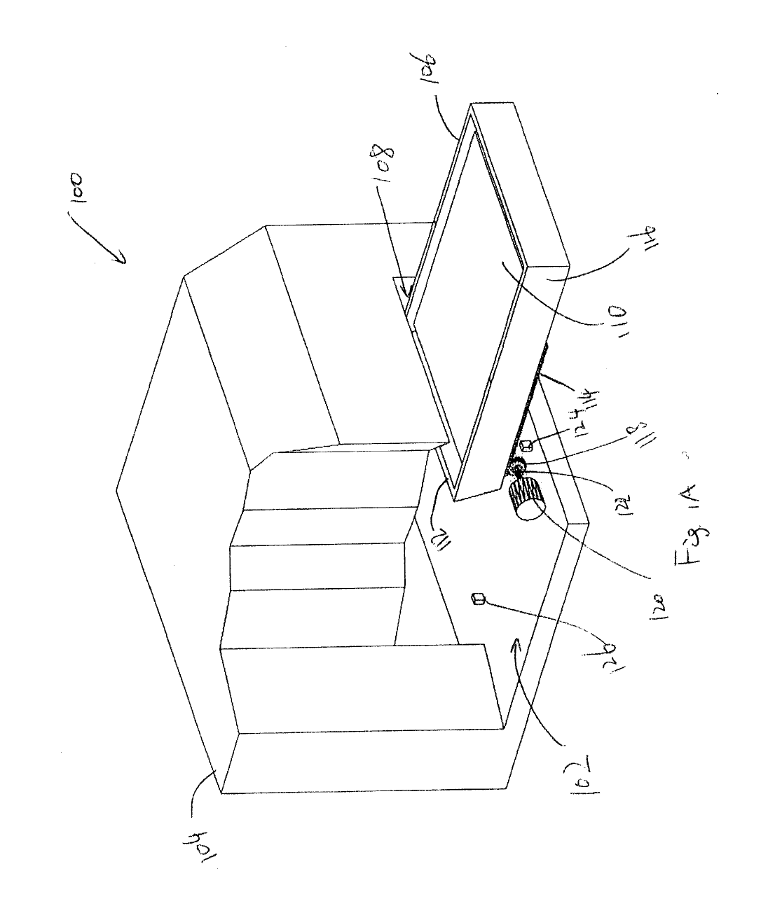

FIGS. 1A and 1B illustrate a first printer embodiment of the present invention, and the printer is referred to herein by the general reference numeral 100. The printer 100 is representative of the many kinds of devices that use paper trays for printing images. For example, some fax and copier machines represent alternative embodiments of the present invention.

The printer 100 includes a chassis 102 disposed within a casing 104. A sliding paper input tray 106 can be pulled out of and inserted back into the printer 100 through an opening 108. Such tray carries a stack of paper sheets 110. During printing, individual sheets of paper are sequentially picked from the input tray and advanced to an image printing mechanism.

The input tray 106 includes a bottom floor on which the paper sheets 110 are stacked, and a sloped front datum wall 112. The input tray 106 includes a gear track 114 mounted to a side wall 116 and that engages a gear 118.

The gear 118 is driven by a motor 120 mounted to the chassis 102 through a gear shaft 122. As the motor 120 rotates, the gear 118 interacts with the gear track to drive the input tray 106 in and out. A mechanism controls the rotation speed of the motor 120 so the speed at which the input tray 106 can be reinserted is limited.

A pair of sensor 124, 126 are also mounted to the chassis 102 for respectively detecting a position of the input tray 102 during the pull-out and insertion of the input tray 106.

An on/off button is provided on the enclosure 104 of the printer 100. When the paper sheets are to be loaded, the user can simply press the on/off button. Such an action automatically triggers the motor 120 to rotate at a predetermined speed in a direction to drive the input tray 106 outwards. In FIG. 1A, when the sensor 124 detects that the input tray has reached a first predetermined position, the sensor 124 sends a signal to the controlling mechanism of the printer 100, and the controlling mechanism then stops the rotation of the motor 120.

After the user has loaded the paper sheets 110 into the input tray 106, the user can press the on/off button again, and this time such an action triggers the motor 120 to rotate at the predetermined speed to drive the input tray 106 inwards. In FIG. 1B, when the sensor 126 detects that the input tray 106 has reached a second predetermined position, the sensor 126 sends a signal to the controlling mechanism of the printer 100, and the controlling mechanism then stops the rotation of the motor 120.

Since the motor 120 rotates at a predetermined speed during the insertion of the input tray 106, the insertion speed at which the input tray 106 is inserted is also controlled. In this way, the paper sheets 110 are prevented from climbing up the front datum 112.

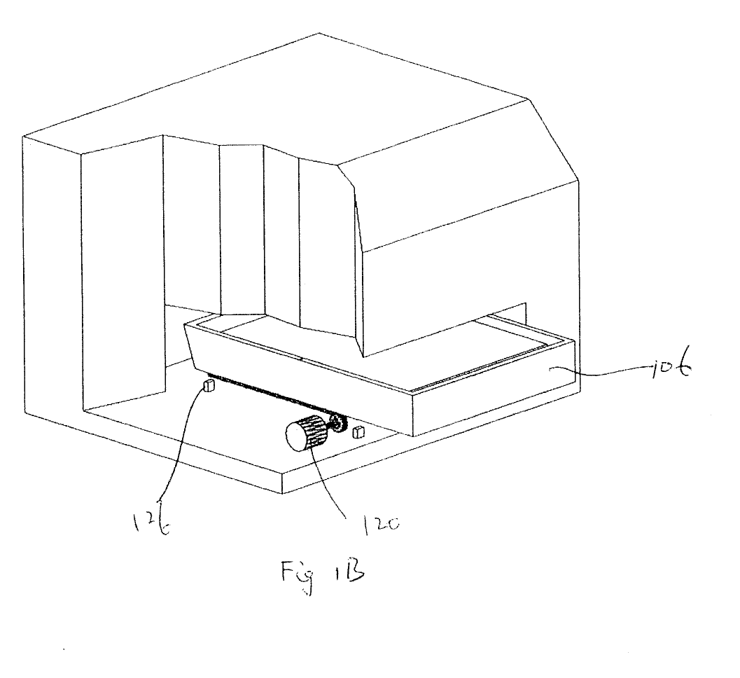

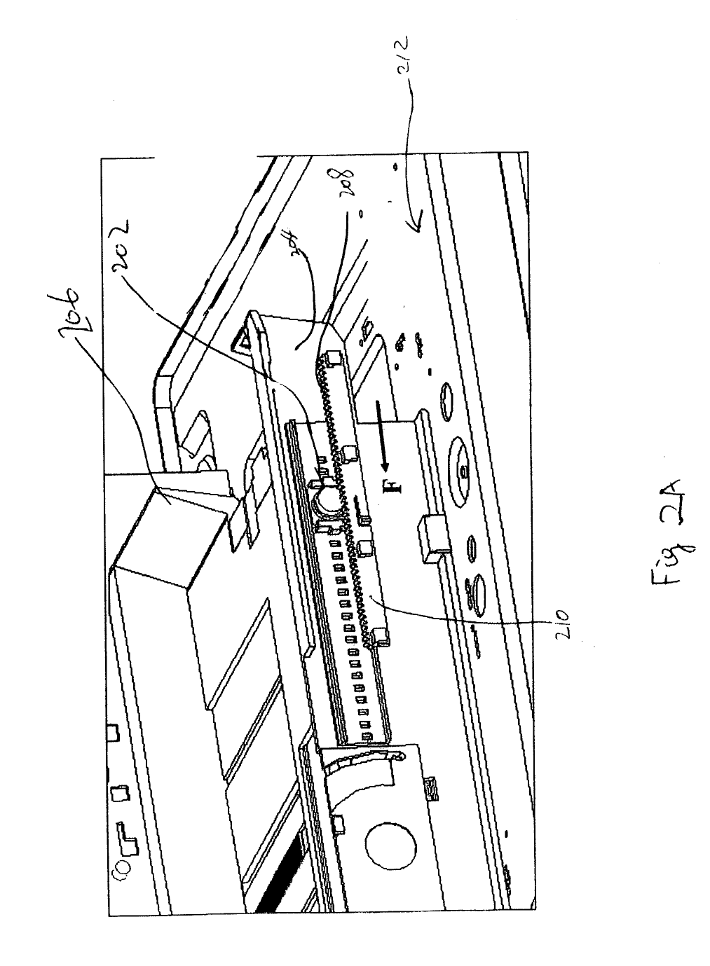

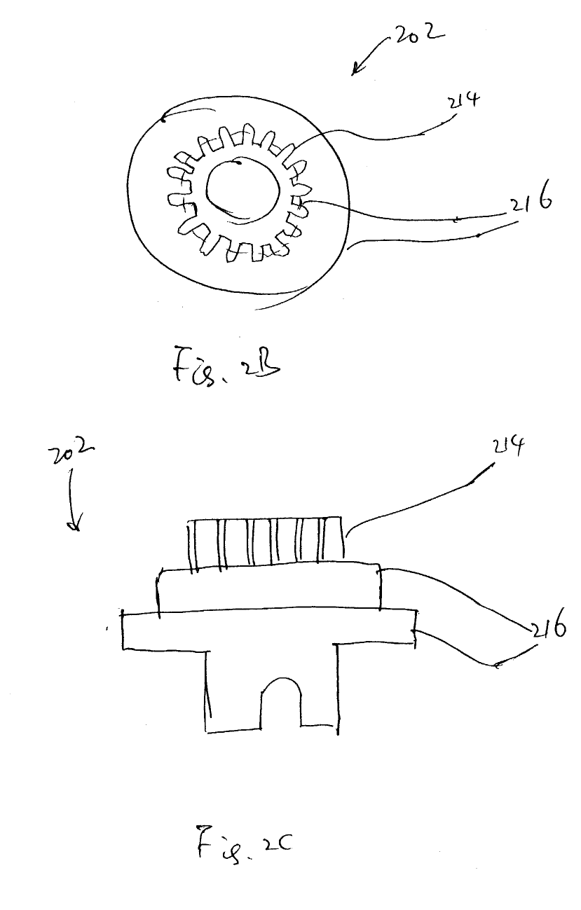

FIGS. 2A-2C partially illustrate a second printer embodiment of the present invention.

In FIG. 2A, a damper 202 is mounted on the side wall 204 of the input tray 206 to engage with a plurality of engaging teeth 208 of a gear track 210. The gear track 210 is mounted to the chassis 212 of the printer and extends lengthwise along the side wall 204 of the input tray 206. During manual insertion of the input tray 206, the damper 202 interacts with the engaging teeth 208 to slow down the insertion speed at which the input tray 206 is inserted into the printer. In this way, the paper sheets are prevented from climbing up the front datum of the input tray 206.

As shown in FIGS. 2B and 2C, the damper 202 has two parts 214, 216. Part 214 serves as a gear to engage the engaging teeth 208. Part 216 serves to fit onto the input tray and to interact with part 214 to generate a damper force. Such damper force slows down the insertion speed. In particular, as the input tray is inserted, the engagement between the engaging teeth and part 214 of the damper drives part 214 to rotate relative to part 216. Such a relative movement between these two parts generates a resistance force or the damper force proportional to the relative speed of these two parts. Therefore, the higher the insertion speed, the higher the relative speed between these two parts and the higher damper force generated.

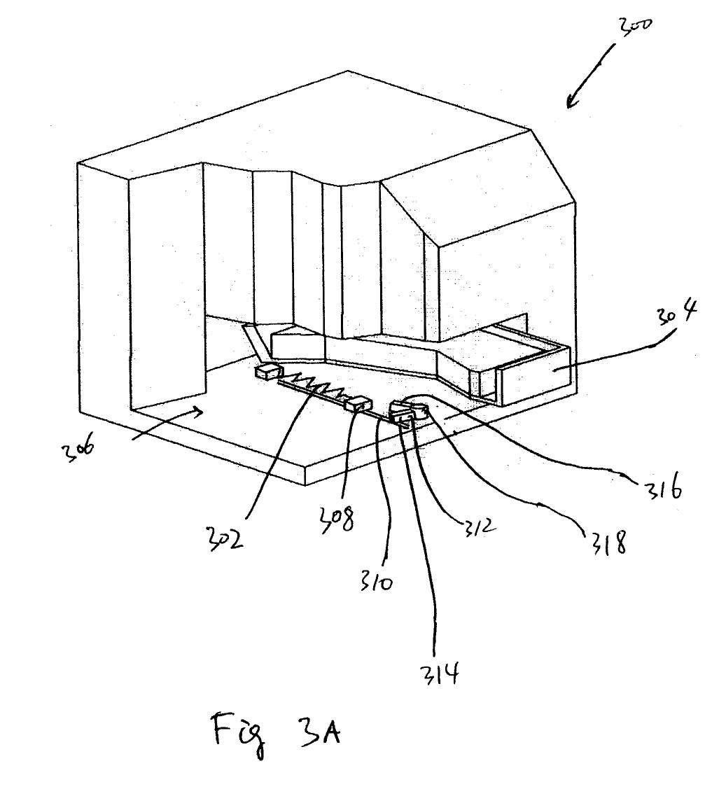

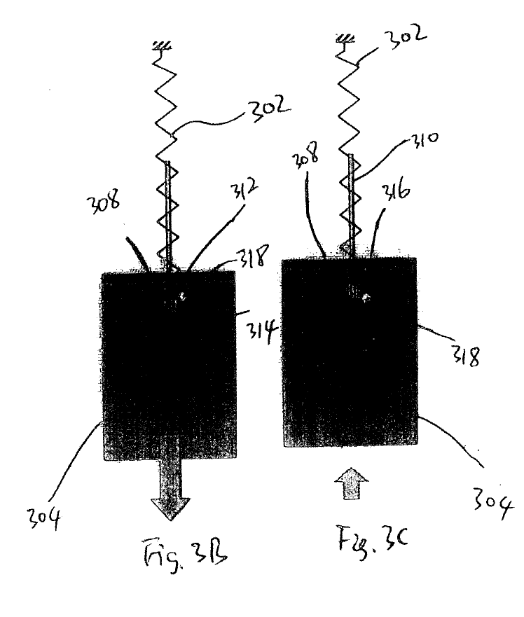

FIGS. 3A-3C illustrate a third printer embodiment of the present invention. A dashpot or damping mechanism is used to limit the speed at which the paper tray can be reinserted by the user.

FIG. 3A, the printer 300 includes a tension spring 302 extending lengthwise along the input tray 304, with one end attached to the chassis 306 and the other end attached to a slider 308 hook onto the input tray 304. The spring 302 provides the driving force for automatically pulling the input tray 304 inwards during the insertion of the input tray.

The slider 308 includes a built-in damper to interact with a gear track 310 mounted on the chassis. The interaction between the built-in damper and the gear track 310 is similar to what has been described with reference to FIGS. 2A and 2B.

Furthermore, a locker 312 is mounted to the chassis 306 for holding the slider 308 when the input tray 304 is fully pulled out for loading paper sheets. Such an action on the slider 308 holds the input tray 304 in position until it is released by an external force.

The slider 308 in the exemplary embodiment has a rectangular shape with a front and a back surface opposite to each other. Correspondingly, the locker 312 includes a pair of arms 314, 316 extending perpendicular to each other for embracing the slider. Both arms are connected at an end to a pivot 318 mounted to the chassis.

In FIG. 3B, the user overcomes the spring force and manually pulls the input tray 304 outwards. When the slider 308 reaches the locker 312, the front surface of the slider 308 pushes the arm 314 of the locker away so that the locker rotates about the pivot 318 by a sufficient degree. After the rotation, the other arm 316 of the locker is in a position for receiving the back surface of the slider 308. The locker 312 functions to prevent the input tray 106 from being pulled back by the spring 302 when the user stops pulling the input tray 304. This can be achieved by the frictional force between the pivot 318 and the chassis 306 designed to resist the spring force exerted on the input tray 304. Alternatively, a self-locking mechanism using mating part interference such as detents and bosses can be used to hold the input tray in position. Furthermore, the locker 312 is positioned such that when the slider reaches the locker, a major portion of the input tray 106 has been pulled out of the printer for loading the paper sheets.

After the paper sheets are loaded into the input tray, in FIG. 3C, the user pushes the input tray inwards. Ideally, the user only needs to exert a small amount of force on the input tray to unlock the locker. When the arm 316, which restricts the slider 308 from moving, is pushed or swung away, the spring 302 automatically pulls the input tray inwards until the input tray reaches a hard stop in the printer when it has been pulled in sufficiently.

During such an automatic insertion of the input tray into the printer, the built-in damper in the slider interacts with the gear track 310 to automatically slow down the insertions speed at which the input tray moves. In this way, the insertion speed is automatically controlled and the paper sheets are prevented from climbing up the front datum of the input tray.

Method embodiments of the present invention prevent the bunching of paper in a media tray when the user reinserts the tray into a printer. Either the media may be locked or pressed down to prevent its slopping around in the tray during reinsertion, or the speed that the tray can be slammed back into the printer is controlled and limited.

Alternatives can be made to the exemplary embodiments. For example, in the second and third embodiments, the gear track can be mounted on the input tray while the damper is mounted to the chassis instead. Furthermore, a compression spring can be used in the third embodiment instead of a tension spring.

What is claimed is:

1. A paper tray, comprising:
paper tray for introducing a stack of paper into a printer and having a datum wall against which paper sheets can bunch up;
a speed control connected to engage the paper tray and limit the speed at which the paper tray can be reinserted by a user into said printer;
wherein, the speed control reduces the frequency with which said paper sheets bunch up against said datum wall.

2. The paper tray of claim 1, wherein:
the speed control includes a motor that power drives any reinsertion of the paper tray into said printer at a controlled speed.

3. The paper tray of claim 1, wherein:
the speed control includes a damper that limits any reinsertion of the paper tray into said printer to a controlled speed.

4. A method for reducing paper mishandling problems in a printer, comprising:
limiting the speed at which a paper tray can be reinserted by a user into a printer;
wherein, any paper in a stack of paper carried in said paper tray is not bunched up against a datum wall that would be caused by slamming and sudden stops.

5. The method of claim 4, wherein:
the step of limiting the speed includes engaging and running a motor that power drives said paper tray back into said printer at a controlled speed.

6. The method of claim 4, wherein:
the step of limiting the speed includes engaging a damper that slows movement of said paper tray back into said printer at a controlled speed.

7. A printer, comprising:
an image printing mechanism;
paper tray for introducing a stack of paper into a printer and having a datum wall against which paper sheets can bunch up;
a paper picker for picking up a piece of paper from the paper tray and for forwarding it to the image printing mechanism;
a speed control connected to engage the paper tray and limit the speed at which the paper tray can be reinserted by a user into said printer;
wherein, the speed control reduces the frequency with which said paper sheets bunch up against said datum wall.

8. The printer of claim 7, wherein:
the speed control includes a motor that power drives any reinsertion of the paper tray into said printer at a controlled speed.

9. The printer of claim 7, wherein:
the speed control includes a damper that limits any reinsertion of the paper tray into said printer to a controlled speed.
